(19) United States
(12) Patent Application Publication
(10) Pub. No.: US 2026/0324726 A1
(43) Pub. Date: Oct. 22, 2026

(54) ATOMIZER, ELECTRONIC ATOMIZATION DEVICE, ATOMIZATION ASSEMBLY, AND MANUFACTURING METHOD

(71) Applicant: SHENZHEN FIRST UNION TECHNOLOGY CO., LTD., Shenzhen, Guangdong (CN)

(72) Inventors: Xuanming LU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/104,673

(22) PCT Filed: Jul. 28, 2023
(86) PCT No.: PCT/CN2023/109805

§ 371 Date: Feb. 18, 2025

(30) Foreign Application Priority Data
Aug. 18, 2022 (CN) 202210993908.1

(51) Int. Cl. A24F 40/46; A24F 40/10; A24F 40/70; H05B 3/06

(52) U.S. Cl. CPC A24F 40/46; A24F 40/10; A24F 40/70; H05B 3/06

(57) ABSTRACT

An atomizer, an electronic atomization device, an atomization assembly, and a manufacturing method are provided. The atomizer includes: a liquid storage cavity for storing a liquid substrate; a porous body in fluid communication with the liquid storage cavity to receive the liquid substrate; and a heating element, at least partially coming in contact with the porous body. The heating element is porous for suctioning the liquid substrate from the porous body and heating the suctioned liquid substrate to generate an aerosol. The heating element is obtained by carbonizing a porous resin gel.

### CROSS-REFERENCE TO RELATED APPLICATIONS

This application claims priority to Chinese Patent Application No. 202210993908.1, filed with China National Intellectual Property Administration on Aug. 18, 2022 and entitled “ATOMIZER, ELECTRONIC ATOMIZATION DEVICE, ATOMIZATION ASSEMBLY, AND MANUFACTURING METHOD”, which is incorporated herein by reference in its entirety.

### TECHNICAL FIELD

Embodiments of this application relate to the technical field of electronic atomization, and in particular to an atomizer, an electronic atomization device, an atomization assembly, and a manufacturing method.

### BACKGROUND

Tobacco products (such as cigarettes, cigars, and the like) burn tobacco during use to produce tobacco smoke. Attempts are made to replace these tobacco-burning products by making products that release compounds without burning.

An example of such products is a heating device, which releases compounds by heating rather than burning a material. For example, the material may be tobacco or other non-tobacco products. These non-tobacco products may or may not include nicotine. In another example, an aerosol-providing product, for example, a so-called electronic atomization device is provided. These electronic atomization devices generally include a liquid, a porous ceramic body, and a metallic or alloy heating element formed or combined on the porous ceramic body, and after being absorbed by porous ceramics, the liquid is heated by the heating element to be vaporized and to generate an inhalable aerosol.

### SUMMARY

An embodiment of this application provides an atomizer, including:
a liquid storage cavity for storing a liquid substrate;
a porous body, in fluid communication with the liquid storage cavity to receive the liquid substrate; and
a heating element, at least partially coming in contact with the porous body, where the heating element is porous for suctioning the liquid substrate from the porous body and heating the suctioned liquid substrate to generate an aerosol; and the heating element is obtained by carbonizing a porous resin gel.

In some embodiments, the heating element does not include a metallic element; or the heating element is nonmetallic.

In some embodiments, the heating element includes carbon.

In some embodiments, the heating element further includes nitrogen or silicon.

In some embodiments, a porosity of the heating element is between 30% and 80%.

In some embodiments, an average pore size of micropores in the heating element is between 1 μm and 10 μm.

In some embodiments, a volume of the heating element is not greater than 8 mm³.

In some embodiments, a volume density of the heating element is 0.4 g/cm³ to 1 g/cm³.

In some embodiments, a mechanical strength of the heating element is not smaller than 20 MPa.

In some embodiments, a Moh's hardness of the heating element is 2 to 3.

In some embodiments, the micropores in the heating element are basically three-dimensionally communicated.

In some embodiments, at least a part of the heating element is exposed on surfaces of the porous body to generate and release the aerosol.

In some embodiments, a volume resistivity of the heating element is between 0.1 (2·mm and 1 Ω·mm.

In some embodiments, the porous resin gel is obtained by enabling organic monomers capable of being polymerized with formaldehyde to take a polymerization reaction with the formaldehyde, and separating a resin product from a reaction system through phase separation.

The “phase separation” is a physicochemical term, and means that when external conditions such as a temperature and a pressure of a system change, a multi-component system may be separated into several phases respectively having different components. For example, when the temperature descends, a multi-component liquid phase may be separated into more than two immiscible liquid phases with different components.

Further, the term “polymerization-induced phase separation” is a chemical method for synthesizing a porous material, and is a method for obtaining the porous material by designing a proportion of each component in a precursor solution, enabling reactants to decrease the compatible degree (miscibility) with other components in the system during a polymerization reaction due to polymerization degree of the reactants increases to take phase separation, and finally “freezing” a phase separation migration structure in a “gel” solidification form.

In some embodiments, the organic monomers include at least one of phenol, resorcinol, phloroglucinol, urea, melamine, dicyandiamide, or derivatives thereof.

In some embodiments, through holes orderly formed in a predetermined direction are further formed on the heating element.

In some embodiments, the through holes penetrate through the heating element in a thickness direction of the heating element.

In some embodiments, a hole size of the through holes is greater than a pore size of the micropores in the heating element; and/or
a diameter of the through holes is between 0.05 mm and 1.0 mm.

In some embodiments, the through holes are visible to naked eyes.

In some embodiments, the heating element is flaky; and the through holes are at least located in a central area of the heating element.

In some embodiments, the heating element is provided with a framework defining internal micropores, and activation pores smaller than 2 nm are formed on a surface of the framework.

In some embodiments, the activation pores are formed by performing activation treatment on the heating element; the activation treatment includes calcination of the heating element in an atmosphere of an active gas, or soaking of the heating element in an active solution; and the active gas includes water vapor or carbon dioxide, and the active solution includes potassium hydroxide or zinc chloride.

In some embodiments, a nitrogen gas absorption and desorption curve of the heating element is a type I isotherm.

Another embodiment of this application further provides an electronic atomization device, including an atomizer for atomizing a liquid substrate to generate an aerosol, and a power supply mechanism for supplying power to the atomizer, where the atomizer includes the above atomizer.

Another embodiment of this application further provides an atomizer, including:
a liquid storage cavity for storing a liquid substrate;
a porous body, in fluid communication with the liquid storage cavity to receive the liquid substrate; and
a heating element, at least partially coming in contact with the porous body, where the heating element is porous for suctioning the liquid substrate from the porous body and heating the suctioned liquid substrate to generate an aerosol; and a volume resistivity of the heating element is between 0.1 Ω·mm and 1 Ω·mm.

Another embodiment of this application further provides an atomization assembly for the electronic atomization device, including:
a porous body, and
a non-metallic heating element, at least partially coming in contact with the porous body, where the heating element is porous for suctioning a liquid substrate from the porous body and heating the suctioned liquid substrate to generate an aerosol; and a volume resistivity of the heating element is between 0.1 Ω·mm and 1 Ω·mm.

Another embodiment of this application further provides an atomizer, including:
a liquid storage cavity for storing a liquid substrate;
a porous body, in fluid communication with the liquid storage cavity to receive the liquid substrate; and
a heating element, at least partially coming in contact with the porous body, where the heating element is porous for suctioning the liquid substrate from the porous body and heating the suctioned liquid substrate to generate an aerosol; and the heating element includes:
a non-metallic framework and micropores formed between the frameworks, the framework being conductive, and
a surface of the framework being smooth.

Another embodiment of this application further provides an atomizer, including:
a liquid storage cavity for storing a liquid substrate;
a porous body, in fluid communication with the liquid storage cavity to receive the liquid substrate; and
a heating element, at least partially coming in contact with the porous body, where the heating element is porous for suctioning the liquid substrate from the porous body and heating the suctioned liquid substrate to generate an aerosol; the heating element is internally provided with disorderly distributed micropores, and the micropores have an average pore size of between 1 μm and 10 μm; and
at least one through hole penetrating through the heating element in a predetermined direction is formed on the heating element, and a diameter of the through hole is greater than the average pore size of the micropores.

In some embodiments, the through hole penetrates through the heating element in a thickness direction of the heating element.

In some embodiments, the through hole is formed through laser perforation.

In some embodiments, the heating element is flaky;
the through hole is at least located in a central area of the heating element; and/or the through hole is close to a geometric center of the heating element.

Another embodiment of this application further provides a manufacturing method for the atomization assembly, including the following steps:
enabling organic monomers capable of being polymerized with aldehyde compounds to take a polymerization reaction with the aldehyde compounds, and separating a resin product of the polymerization reaction from a reaction system through phase separation to obtain a porous resin gel;
carbonizing the porous resin gel to obtain a heating element; and
obtaining a porous body, and combining the heating element onto the porous body.

According to the foregoing atomizer, the porous heating element is obtained by carbonizing the porous resin gel. It is advantageous for the liquid substrate to be atomized.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements having same reference numerals in the accompanying drawings are represented as similar elements, and unless otherwise particularly stated, the figures in the accompanying drawings are not drawn to scale.

FIG. 1 is a schematic diagram of an electronic atomization device provided by an embodiment.

FIG. 2 is a schematic diagram of an embodiment of an atomizer in FIG. 1.

FIG. 3 is a schematic structural diagram of an atomization assembly in FIG. 2 in a view angle.

FIG. 4 is a schematic exploded view of the atomization assembly in FIG. 3 in a view angle.

FIG. 5 is a schematic diagram of a manufacturing method for a heating element in an embodiment.

FIG. 6 is a cross-section electron microscope scannogram of one magnification of a heating element in an embodiment.

FIG. 7 is a cross-section electron microscope scannogram of one magnification of a heating element in another embodiment.

FIG. 8 is a cross-section electron microscope scannogram of one magnification of a heating element in further another embodiment.

FIG. 9 is a cross-section electron microscope scannogram of one magnification of a heating element in further another embodiment.

FIG. 10 is a cross-section electron microscope scannogram of one magnification of a heating element in further another embodiment.

FIG. 11 is a cross-section electron microscope scannogram of one magnification of a heating element in further another embodiment.

FIG. 12 is a cross-section electron microscope scannogram of one magnification of a heating element in further another embodiment.

FIG. 13 is a schematic exploded view of a porous body and a heating element of an atomization assembly before assembly according to another embodiment.

FIG. 14 is a schematic diagram of a heating element of another embodiment.

FIG. 15 is a comparison diagram of nitrogen gas adsorption curves before and after activation treatment of a porous heating element in an embodiment.

### DETAILED DESCRIPTION

The technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are used for descriptive purposes only and should not be construed as indicating or implying relative importance or implicitly indicating the number or sequence of indicated technical features. All directional indications (such as up, down, left, right, front, and back) in the embodiments of this application are only used for explaining relative position relationships, or movement situations, or the like between components in a specific posture (as shown in the accompanying drawings). If the specific posture changes, the directional indications change accordingly. In addition, the terms “include” and “have”, and any variant thereof are intended to cover a non-exclusive inclusion. For example, a process, method, system, product, or apparatus that includes a series of steps or units is not limited to the listed steps or units; and instead, further optionally includes a step or unit that is not listed, or further optionally includes another step or unit that is intrinsic to the process, method, product, or apparatus.

“Embodiment” mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

It should be noted that, when a component is referred to as “being fixed to” another component, the component may be directly on another component, or an intervening component may be present. When a component is considered to be “connected to” another component, the component may be directly connected to another component, or one or more intervening components may also be present. The terms “vertical”, “horizontal”, “left”, and “right”, and similar expressions used in this specification are only for the purpose of description but not indicate a unique implementation.

This application provides an electronic atomization device. Referring to FIG. 1, the electronic atomization device includes: an atomizer 100, storing a liquid substrate and configured to atomize the liquid substrate to generate an aerosol; and a power supply assembly 200, configured to supply power to the atomizer 100.

In an optional embodiment, as shown in FIG. 1, the power supply assembly 200 includes: a receiving cavity 270, arranged on an end in a length direction and configured to receive and accommodate at least a part of the atomizer 100; and first electrical contacts 230, at least partially exposed out of a surface of the receiving cavity 270 and configured to supply power to the atomizer 100 when at least one part of the atomizer 100 is received and accommodated in the power supply assembly 200.

According to implementation as shown in FIG. 1, second electrical contacts 21 are arranged on an end portion of the atomizer 100 in the length direction opposite to the power supply assembly 200, so when at least a part of the atomizer 100 is received in the receiving cavity 270, the second electrical contacts 21 are in contact with and abuts against the first electrical contacts 230 to form electrical conduction.

A sealing member 260 is arranged in the power supply assembly 200, and at least a part of an internal space of the power supply assembly 200 is separated through the sealing member 260 to form the foregoing receiving cavity 270. During implementation as shown in FIG. 1, the sealing member 260 is constructed to extend in a cross-section direction of the power supply assembly 200, and is optionally made of a flexible material to prevent the liquid substrate seeping from the atomizer 100 to the receiving cavity 270 from flowing to components such as a controller 220 and a sensor 250 inside the power supply assembly 200.

During implementation as shown in FIG. 1, the power supply assembly 200 further includes a battery cell 210, backing away from the other end of the receiving cavity 270 in a length direction and configured to supply power; and a controller 220, arranged between the battery cell 210 and an accommodation cavity the controller 220 operably guiding a current among the battery cell 210 and the first electrical contacts 230.

In use, the power supply assembly 200 includes a sensor 250, configured to sense a suction air flow generated when the atomizer 100 is vaped, so that the controller 220 controls the battery cell 210 to output a current to the atomizer 100 according to a detection signal of the sensor 250.

Further, during implementation as shown in FIG. 1, a charging interface 240 is arranged on the other end of the power supply assembly 200 backing away from the receiving cavity 270, and is configured to charge the battery cell 210.

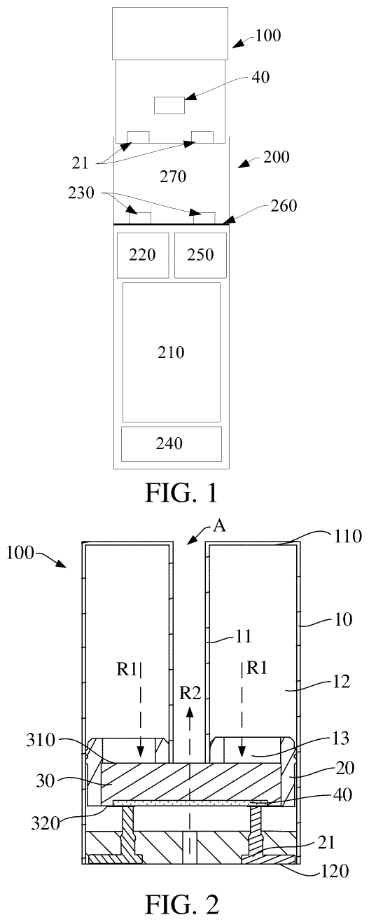

According to an embodiment in FIG. 2, a schematic structural diagram of an embodiment of the atomizer 100 in FIG. 1 is shown. The atomizer includes:
a main housing 10. As shown in FIG. 2, the main housing 10 is approximately in a longitudinal tubular shape, has the hollow inside of course, and is a necessary function component for storing and atomizing the liquid substrate; and the main housing 10 has a near end 110 and a far end 120 opposite each other in a length direction. Based on a common use demand, the near end 110 is configured to be used as an aerosol suction end for a user, and a suction nozzle A for the user to vape is arranged on the near end 110; and the far end 120 is used as one end combined with the power supply assembly 200.

Further, referring to FIG. 2, a liquid storage cavity 12 for storing the liquid substrate and an atomization assembly configured to suck the liquid substrate from the liquid storage cavity 12 and heat and atomize the liquid substrate are arranged inside the main housing 10. In a schematic diagram shown in FIG. 2, an aerosol conveying tube 11 arranged in an axial direction is arranged in the main housing 10, and the liquid storage cavity 12 for storing the liquid substrate is formed in a space between the aerosol conveying tube 11 and an inner wall of the main housing 10; and a first end of the aerosol conveying tube 11 opposite to the near end 110 communicates with the suction nozzle A, so that the generated aerosol is conveyed to the suction nozzle A to be vaped.

Further, in some optional implementations, the aerosol conveying tube 11 and the main housing 10 are integrally formed by using a moldable material, so that the manufactured liquid storage cavity 12 is open or is provided with an opening towards the far end 120.

Further referring to FIG. 2 and FIG. 3, the atomizer 100 further includes an atomization assembly, configured to atomize at least a part of the liquid substrate to generate an aerosol. Specifically, the atomization assembly includes a porous body 30; and a heating element 40 configured to suck the liquid substrate from the porous body 30 and perform heating vaporization. In addition, in some implementations, the porous body 30 may be made of a rigid capillarity element such as porous ceramics, porous glass ceramics and porous glass. Or, in some other implementations, the porous body 30 includes a capillarity element internally provided with a capillarity channel and being capable of absorbing and conveying the liquid substrate.

The atomization assembly is accommodated and held in the sealing member 20, in addition, the porous body 30 of the atomization assembly is in fluid communication with the liquid storage cavity 12 through a liquid guide channel 13 defined by the sealing member 20 so as to receive the liquid substrate. In use, as shown by an arrow R1 in FIG. 2, the liquid in the liquid storage cavity 12 flows to the atomization assembly through the liquid guide channel 13, and is then absorbed and heated; and then, the generated aerosol is output to the suction nozzle A through the aerosol conveying tube 11 to be vaped by a user, as shown by an arrow R2 in FIG. 2.

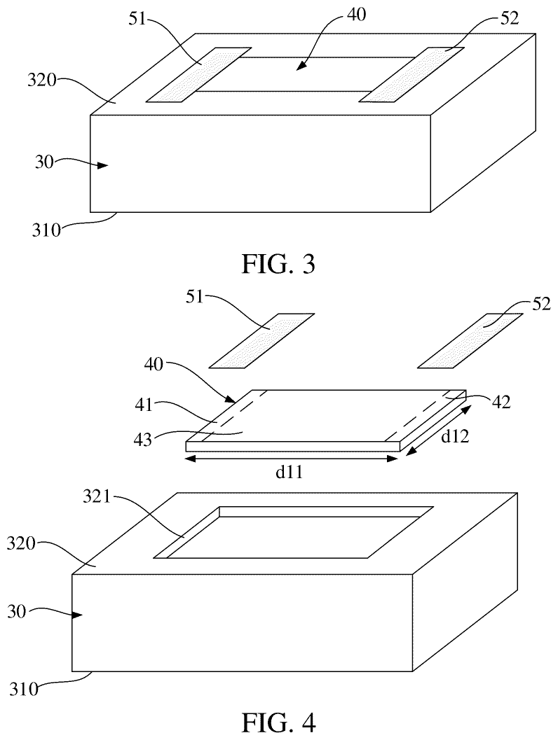

Further, referring to FIG. 3 to FIG. 4, a specific construction of the atomization assembly includes:
a porous body 30 provided with a surface 310 and a surface 320 backing away from each other, where after the assembly, the surface 310 faces the liquid storage cavity 12, and is in fluid communication with the liquid storage cavity 12 through the liquid guide channel 13 to suck the liquid substrate; and the surface 320 backs away from the liquid storage cavity 12.

In some implementations, the porous body 30 is manufactured by mixing raw material power such as ceramic power with a pore forming material, and then performing moulding and sintering. Moreover, the micropores in the porous body 30 are formed through sintering by using the pore forming material. Moreover, the average pore size of the micropores in the porous body 30 is 15 μm to 50 μm. Moreover, the porosity of the porous body 30 is 35% to 75%. The ceramic material powder of the porous body 30 includes at least one of aluminum oxide, zirconium oxide, magnesium oxide, calcium oxide, silicon dioxide, cordierite, etc.

In this embodiment, the porous body 30 is approximately in a flaky shape or a plate shape or a block shape, and two side surfaces opposite to each other in a thickness direction are respectively used as a surface 310 and a surface 320. Or, in more embodiments, the porous body 30 may be in more shapes, such as an arch shape, a cup shape and a channel shape. Or, for example, in Chinese Patent Application No. CN215684777U, the applicant provides configuration details about an arch shape of the porous body with an inner channel, and the porous body sucking the liquid substrate and atomizing the liquid substrate, which is incorporated by reference in its entirety.

In addition, during implementation, the surface 320 has a length size about 8 mm to 15 mm, and a left and right width size about 3 mm to 8 mm. In addition, during implementation, a groove 321 is formed on the surface 320. The heating element 40 is assembled and held in the groove 321. The groove 321 basically extends in a length direction of the surface 320. Moreover, a length and a width of the groove 321 are the same as a length and a width of the heating element 40, or the length and the width of the groove 321 are slightly greater than the length and the width of the heating element 40; and therefore, the heating element 40 may be smoothly and firmly assembled and held in the groove 321.

In addition, further referring to FIG. 3 to FIG. 4, the heating element 40 of the atomization assembly is porous; and pores of micropores are formed inside the heating element 40, and the heating element 40 may further suck and heat the liquid substrate from the porous body 30 through further coming in contact with the porous body 30.

Moreover, at least a part of the heating element 40 is exposed on the surface 320 to release the generated aerosol.

Or, in some other variants embodiments, the surface 320 of the porous body 30 is flat; and the foregoing groove 321 is not formed on the surface 320. The heating element 40 is directly combined to the surface 320 of the porous body 30 in a manner such as surface mounting, welding, mechanical fixation or bonding slurry sintering.

In addition, in some implementations, the heating element 40 is a thin flake. For example, as shown in FIG. 4, the heating element 40 is constructed to be in a basically thin flake shape or a plate shape. The “thin” may be described as that a thickness of the heating element 40 is smaller than a length and/or a width. In addition, in the implementation of FIG. 4, the heating element 40 has a length size d11 of approximately 6 mm to 14 mm, and a width size d12 of 2 mm to 6 mm; and the heating element 40 has a thickness about 0.2 mm to 2 mm. Therefore, the heating element 40 has a great contact area with the porous body 30, and it is advantageous to improve the transferring efficiency of the liquid substrate between the heating element and the porous body; and it is at least advantageous for preventing dry burning when the liquid substrate sucked by the heating element 40 is insufficient. Or, in some other embodiments, the heating element 40 is a block body with a greater thickness, etc.

In some embodiments, the heating element 40 is non-metallic; or the heating element 40 does not include a metallic element or a metallic component. Moreover, the heating element 40 is a non-metallic porous heating element 40 manufactured by a resin gel method. For example, the heating element 40 at least includes carbon; or the heating element 40 further includes non-metallic nitrogen or silicon.

In some implementations, after the heating element 40 and the porous body 30 are separately manufactured, the heating element 40 is fixed, assembled, or combined on the surface 320 of the porous body 30 to be combined into an integration in a manner such as embedding or mechanical fixation.

Further, as shown in FIG. 3 to FIG. 4, the atomization assembly further includes:
an electrode 51 and an electrode 52, configured to guide a current in a length direction of the heating element 40; and
the electrode 51 and the electrode 52 are at least partially formed on the surface 320 of the porous body 30. Moreover, after the assembly, the electrode 51 is in contact or conduction with a part of a surface of a portion 41 of the heating element 40; and the electrode 52 is in contact or conduction with a part of a surface of a portion 42 of the heating element 40. Moreover, after the assembly, the electrode 51 completely or at least partially covers the portion 41 of the heating element 40; and the electrode 52 completely or at least partially covers the portion 42 of the heating element 40. In addition, an extension size of the electrode 51 and the electrode 52 in a width direction of the surface 320 is greater than a width size of the heating element 40.

In addition, the electrode 51 spans across a groove 321 or the heating element 40 in the width direction; and the electrode 52 spans across the groove 321 or the heating element 40 in the width direction.

In addition, during implementation, the electrode 51 and the electrode 52 at least partially support or hold the heating element 40 at the surface 320, so as to firmly hold the heating element 40 in the groove 321 and prevent the heating element 40 from falling out from the groove 321. For example, in some implementations, the electrode 51 and/or the electrode 52 are/is a thin electrode flake(s), an electrode plate(s) or an electrode disk(s). The electrode 51 and/or the electrode 52 are/is combined onto the surface 320 through welding, mechanical fixation, etc., so the electrode 51 and the electrode 52 are conducted with the heating element 40. Or, exposed surfaces of the portion 41 and the portion 42 of the heating element 40 are coated with conductive slurry such as silver slurry during manufacturing, then the electrode 51 and the electrode 52 are fixed on the surface 320 by welding or mechanical fixation, and the conductive slurry is solidified to form electrical conduction.

Or, in some other implementations, the electrode 51 and the electrode 52 are formed through printing, deposition, etc. For example, the electrode 51 and the electrode 52 may be formed by printing or depositing the conductive slurry onto the surface 320, and at least partially infiltrating the conductive slurry into a seam between the portion 41 of the heating element 40 and the groove 321 and a seam between the portion 42 and the groove 32, and then performing sintering or solidification. In addition, after the sintering or solidification, the conductive slurry infiltrated between the portion 41 and the groove 32 and between the portion 42 and the groove 32 at least partially provides the connection between the portion 41 and/or the portion 42 and the porous body 30. In addition, the electrode 51 and the electrode 52 formed by the conductive slurry are respectively at least partially immersed or infiltrated into pores of the micropores of the portion 41 and the portion 42.

Moreover, after the assembly, the electrode 51 and the electrode 52 are exposed; and second electrical contacts 21 of the atomizer 100 extend into the atomizer 100 from the far end 120 and are abutted onto the electrode 51 and the electrode 52 to form conduction so as to supply power to the heating element 40. In addition, during implementation, the portion 41 and the portion 42 of the heating element 40 are used for defining electric connection areas of the heating element 40, so as to supply power to the heating element 40 in use. In addition, the portion 43 of the heating element 40 mainly defines a heating area of the liquid substrate.

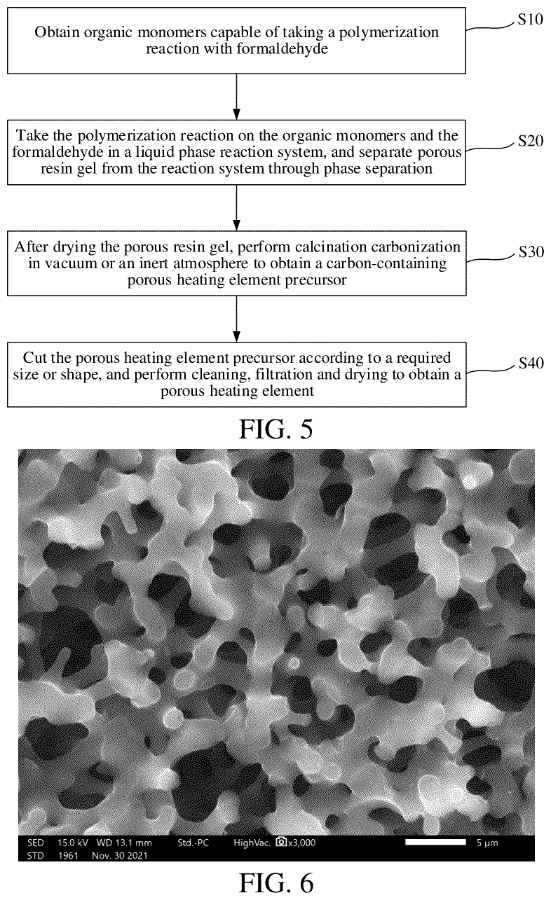

Another embodiment of this application further provides a method for manufacturing the non-metallic porous heating element 40 by a resin gel method. As shown in FIG. 5, the method includes the following:
S10: organic monomers capable of taking a polymerization reaction with formaldehyde are obtained.

The term “monomer” is a noun term in the field of organic chemistry. The monomer is a general term for micromolecules capable of being polymerized with the same or other types of molecules, is a simple compound capable of taking a polymerization reaction, a polycondensation reaction or the like to synthesize a high-molecular compound, and is a low-molecular raw material used in the synthesis of polymers. Generally, the “organic monomer” is a carbon-containing monomer.

This type of organic monomers in step S10 are, for example, one or more of phenol, resorcinol, phloroglucinol, urea, melamine, methylbenzene, xylene, dicyandiamide, or their same type derivatives such as derivatives containing silicon oxygen bonds. This type of organic carbon sources may take a polymerization reaction with formaldehyde to form polymer resin; and for example, the phenol/resorcinol/phloroglucinol may take a polycondensation reaction with the formaldehyde to from phenolic resin, for another example, the urea may take a polycondensation reaction with the formaldehyde to from urea resin, and for further another example, the melamine may take a polycondensation reaction with the formaldehyde to from melamine resin, etc.
S20: the above organic monomers take the polymerization reaction with the formaldehyde in a liquid phase reaction system under a catalysis effect of acid, alkali or metal salt, and a reaction system is subjected to phase separation to obtain a porous resin gel product through separation.
S30: after being dried, the porous resin gel in step S20 is subjected to calcination carbonization in vacuum or an inert atmosphere to manufacture and obtain a carbon-containing porous heating element precursor.
S40: the porous heating element precursor is cut, cleaned, subjected to impurity removal, filtered, and dried according to a required size or shape, and then, the heating element 40 is obtained.

The liquid phase reaction system built in step S10 is realized through a liquid phase solvent. Generally, the liquid phase reaction system is generally built by a reaction solvent manufactured from water, methyl alcohol, ethyl alcohol, etc. as the phenolic resin.

Or, in some other embodiments, the organic monomers in step S10 may take a polymerization reaction with aldehyde compounds such as acetaldehyde or propionaldehyde; and may be further polymerized with the aldehyde compounds such as acetaldehyde or propionaldehyde to produce phenolic resin gel.

In step S20, “phase separation” is a physicochemical term, and means that when a temperature, a pressure, or the like of a system, or a ratio, compatibility, or the like of components changes, a multi-component system may be separated to form several phases respectively having different components. For example, when the temperature descends, the multi-component liquid phase may be separated to form an immiscible liquid phase with more than two different components, or a solid phase and a liquid phase, etc.

Further, the term “polymerization-induced phase separation” is a chemical method for synthesizing a porous material, and is a method for obtaining the porous material by designing a proportion of each component in a precursor solution, inducing reactants to decrease the compatible degree (miscibility) with other components in the reaction system during a polymerization reaction due to polymerization degree increases to take phase separation, and finally “freezing” a phase separation migration structure in a “gel” solidification form.

Specifically, for example, in step S20, at an initial stage, a system including a solvent, the reactants and a catalyst is basically in a homogeneous state. However, in the reaction process, as the generation quantity of a resin product increases, the compatibility between the resin product and the reaction system gradually becomes worse. At this moment, the reaction system is no longer thermodynamically compatible, and phase separation starts to occur. The system pursues the smallest surface energy, so the phase structure may gradually coarsen.

In addition, in a phase separation induction process in step S20, formaldehyde may be added to the system to increase a concentration of the formaldehyde monomers, so that when the phase state of the system in the phase separation induction process is converted from dispersed pores to a reverse phase structure, the system conforms to a “spinodal decomposition mechanism”, the pores and the pore sizes of the formed resin gel are increased, and porous resin gel is obtained. In a reaction system in which phase separation induction organic monomers are polymerized with the formaldehyde, if the concentration of the formaldehyde is low, a porous structure with accumulated spherical particles, or a fine-framework three-dimensionally communicated porous structure is formed; and if the concentration of the formaldehyde is high, a thick-framework three-dimensionally communicated porous structure with a large pore size is formed.

In addition, in the reaction process in step S20, an acidic or metal salt catalyst may accelerate the hydroxymethylation speed in the polymerization process. The acidic catalyst is, for example, hydrochloric acid, nitric acid, etc.; or the metal salt catalyst is, for example, ferric chloride, etc.

In step S30, the generated resin gel is further dried and is then subjected to calcination carbonization in vacuum or in the inert atmosphere, so that the gel is decomposed to form a porous heating element precursor basically only including carbon or carbon and nitrogen. Carbonization is also referred to as charring, coking, and the like, and refers to a reaction process of decomposing a solid or an organic substance through heating under a condition of a non-oxidative atmosphere. In the carbonization process, calcination is performed in a carbonization furnace apparatus in an inert atmosphere or under the vacuum condition at a temperature of 500° C. to 2000° C. In some implementations, a calcination temperature in the carbonization process in step S30 should be higher than 600° C. to ensure that the electrical resistivity may satisfy an atomization requirement. In some another embodiments, the calcination temperature in the carbonization process should be higher than or equal to 900° C.

Or, in some specific embodiments, the method for manufacturing the non-metallic porous heating element 40 by using a resorcinol and formaldehyde resin gel method includes the following:
S10: resorcinol is obtained.
S20: 1 mol of the resorcinol is dissolved into 200 ml of dilute nitric acid with a pH value being 2, then, 25 ml to 30 ml of ethyl alcohol is added, and next, 2 mol of formaldehyde is added. After being stirred to a uniformly mixed state, the mixture is placed into a 40° C. incubator for still standing reaction for 24 h, a liquid layer containing a resin product is separated, and then, washing and drying are performed to obtain porous resin.
S30: after the porous resin is placed in an inert-atmosphere furnace or a vacuum furnace for carbonization, a porous carbon heating element 40 may be obtained. According to carbonization temperature conditions, the temperature is raised to 1500° C. at a speed of 8° C./min, and is kept for 2 h.

Or, in some specific embodiments, the method for manufacturing the non-metallic porous heating element 40 by using a phenol and formaldehyde resin gel method includes the following:
S10: phenol is obtained.
S20: 0.5 mol of phenol and 0.5 mol of urea are dissolved into 100 ml to 400 ml of dilute nitric acid with a pH value being 1 to 5, 1 ml to 100 ml of ethyl alcohol is added, and then, 2 mol of formaldehyde is added. After being stirred to a uniformly mixed state, the mixture is placed into a 40° C. incubator for still standing reaction for 24 h, and the porous resin is obtained.
S30: after the porous resin is washed, dried and carbonized in vacuum, porous carbon may be obtained. According to carbonization temperature conditions, the temperature is raised to 600° C. to 2000° C. at a speed of 1° C./min to 10° C./min, and is kept for 1 h to 6 h for carbonization.

Or, in some specific embodiments, the method for manufacturing the non-metallic porous heating element 40 by using a resorcinol and formaldehyde resin gel method includes the following:
S10: resorcinol is obtained.
S20: the resorcinol, the formaldehyde and a 1M hydrochloric acid solution are mixed according to a mass ratio of 6:6:8, then, ethyl alcohol with a volume ratio of 1:1.5 to the hydrochloric acid is added, and stirring is performed till all materials are dissolved to build a reaction system. The materials are transferred to be under induction by an ice bath condition for continuous reaction, a formaldehyde solution with a volume ratio of 1:1 to absolute ethyl alcohol and with a mass ratio of 37% is added, and the reaction is performed for 30 minutes under stirring. A layering phenomenon of the reaction system is observed, and after the stratification is basically stable, a separation phase containing resin sol is separated from the reaction system, and aging and shaping are performed in a mold to obtain porous resin gel.
S30: the porous resin gel is dried at 50° C. for 24 h, and is then transferred to a 100° C. condition to be further dried for 6 h. Next, the dried dry gel is calcined for carbonization at 800° C. for 5 h to obtain a porous heating element precursor.

In the above specific implementation, in the total quantity of added reactants, the mole ratio of the resorcinol to the formaldehyde is 1.1 to 1.8. In step S20, the formaldehyde is added twice. Once is the addition together with the resorcinol when the reaction system is built, and once is addition during ice bath induction, and the twice addition may decelerate reaction heat release and reduce the content of free phenol in the system.

In addition, in some other embodiments, a range of the electrical resistivity may be adjusted by adjusting the porosity, and in a specific embodiment, the electrical resistivity of the porous heating element 40 obtained through calcination carbonization at 1600° C. is 0.3 Ω·mm. If the carbonization temperature is raised to 2000° C., the electrical resistivity of the porous heating element 40 obtained through calcination carbonization is lowered to 0.1 Ω·mm. For example, in some embodiments, the electrical resistivity of the porous heating element 40 having the porosity being 10% and obtained through calcination carbonization at 1600° C. is about 0.15 Ω·mm.

Further, in the above manufacturing, by adjusting the amount of the solution and the amount of the formaldehyde in the reaction system, the pore and the pore size of the generated gel may be adjusted, and the required pore and pore size in the heating element 40 may be manufactured and obtained. For example, FIG. 6 is a microstructure diagram of a cross section of the heating element 40 manufactured under the condition of a relatively small amount of formaldehyde at the 3000 times magnification of an electron microscope in an embodiment. From the cross section in FIG. 6, the pore size of micropores of a three-dimensional network formed by connection in the heating element 40 in this embodiment is mainly 2 μm to 4 μm. In addition, for example, FIG. 7 is a microstructure diagram of a cross section of the heating element 40 manufactured under the condition of a relatively great amount of formaldehyde and solvents at different magnifications of an electron microscope in another embodiment. From the cross section in FIG. 7, the pore size of micropores of a three-dimensional network formed by connection in the heating element 40 in this embodiment is mainly 4 μm to 8 μm. In some embodiments, a mole ratio of the organic monomers for polycondensation to the aldehyde compounds such as formaldehyde is 1.1 to 5.0, and it is advantageous for maintaining the pore size of micropores of the three-dimensional network.

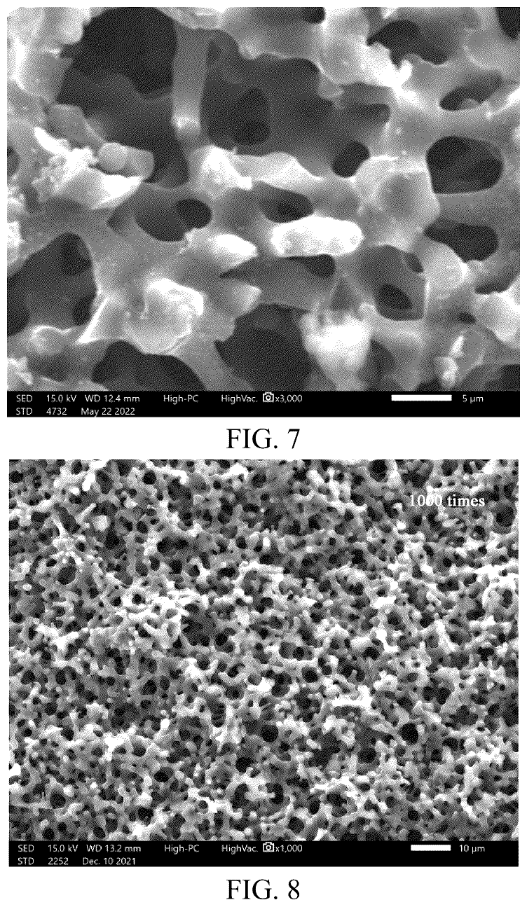

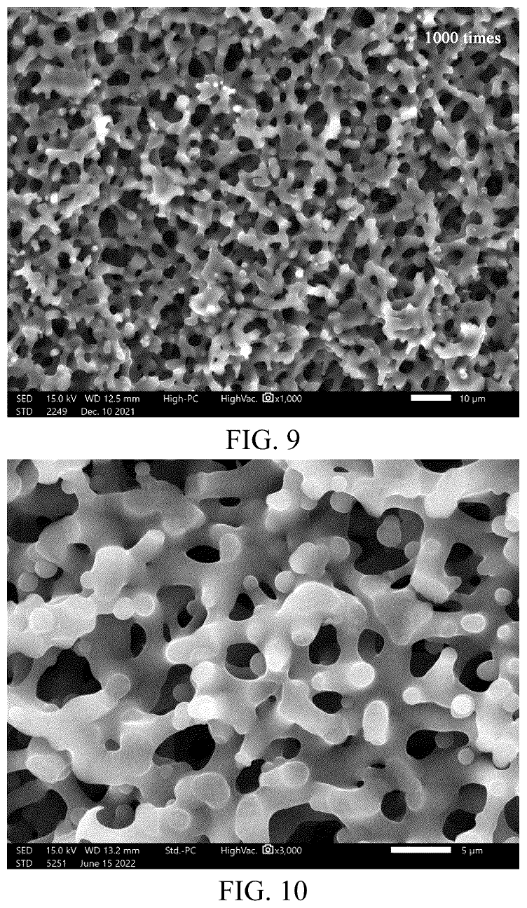

Or, further, FIG. 8 to FIG. 9 show microstructure diagrams of cross sections of the heating elements 40 manufactured by building reaction systems with ethyl alcohol solvents at different multiple proportions and at different magnifications of an electron microscope in a plurality of embodiments. Through the solvents of different multiple proportions, the gel has different volumes, so that the manufactured heating elements 40 have different pores and pore sizes. For example, if the magnification is 1000 times, the porosity and the pore size of the heating element 40 manufactured by using a small number of ethyl alcohol solvents in FIG. 8 are greater than the porosity and the pore size of the heating element 40 manufactured by using an ethyl alcohol solvent of a great multiple proportion in FIG. 9.

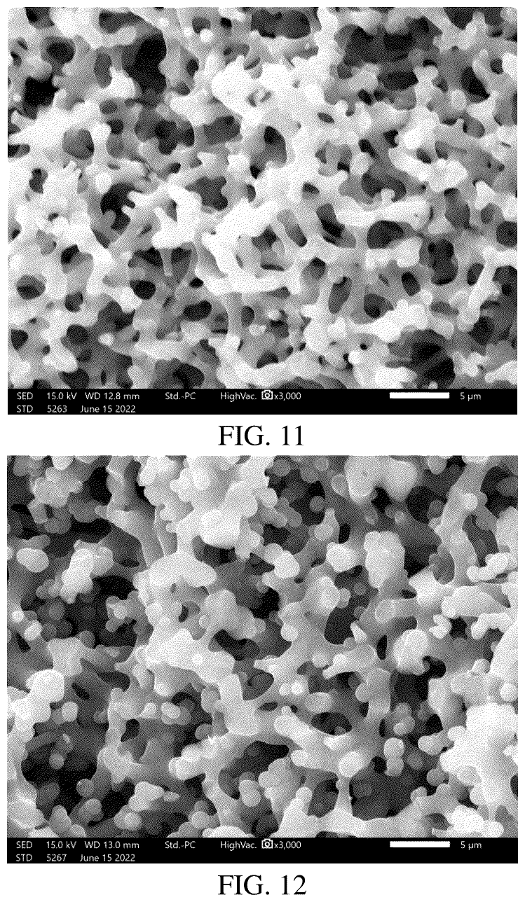

Or, further, FIG. 10 to FIG. 12 respectively show microstructure diagrams of cross sections of the heating elements 40 manufactured by using ferric chloride salts of different concentrations of 0.2 mmol, 0.4 mmol and 0.8 mmol as catalysts at different magnifications of an electron microscope. It can be seen from FIG. 10 to FIG. 12 that a relatively low concentration of the metallic catalyst is advantageous for generating a large pore size.

In an embodiment, the micropores in the porous heating element 40 are basically three-dimensionally communicated; or the micropores in the porous heating element 40 are of co-continuous structures or spinodal-like structures.

In addition, during implementation, by adjusting the quantity of the reactant, or the reaction conditions, or the concentration of the catalyst, etc., the porosity of the manufactured porous heating element 40 is maintained at 30% to 80%.

In a specific embodiment, a manufactured porous heating element 40 was taken to be measured according to a national standard GB/T 21650.1-2008 mercury intrusion method, and the distribution of the pores of the micropores inside the heating element 40 manufactured in an embodiment was as Table 1 below:

| Mercury | Pore | Volume | Difference | Proportion |
|---|---|---|---|---|
| intrusion | size | proportion | value % from | % of pore |
| pressure | range | % in all | a former pore | sizes of each |
| (psia) | (μm) | micropores | size range | section |
| 0.52 | >348.0115 | 0 | 0 | 2.37 |
| 0.64 | >282.3084 | 0.48 | 0.48 | |
| 0.76 | >237.7458 | 0.97 | 0.49 | |
| 0.89 | >203.1277 | 1.21 | 0.24 | |
| 0.96 | >188.9517 | 1.34 | 0.13 | |
| 1.02 | >177.7367 | 1.45 | 0.11 | |
| 1.24 | >145.3604 | 1.68 | 0.23 | |
| 1.49 | >121.4475 | 1.8 | 0.12 | |
| 2.00 | >90.5461 | 2.01 | 0.21 | |
| 2.49 | >72.5811 | 2.11 | 0.10 | |
| 2.99 | >60.4606 | 2.13 | 0.02 | |
| 3.49 | >51.8053 | 2.2 | 0.07 | |
| 3.99 | >45.3349 | 2.22 | 0.02 | |
| 4.49 | >40.285 | 2.25 | 0.03 | |
| 4.99 | >36.2577 | 2.25 | 0.00 | |
| 5.99 | >30.2051 | 2.28 | 0.03 | |
| 6.98 | >25.8962 | 2.36 | 0.08 | |
| 7.98 | >22.6623 | 2.37 | 0.01 | |
| 8.98 | >20.1374 | 2.37 | 0.00 | 0.14 |
| 9.98 | >18.1238 | 2.42 | 0.05 | |
| 10.98 | >16.4796 | 2.42 | 0.00 | |
| 11.97 | >15.1068 | 2.45 | 0.03 | |
| 12.97 | >13.9457 | 2.45 | 0.00 | |
| 13.97 | >12.9492 | 2.46 | 0.01 | |
| 15.96 | >11.3345 | 2.48 | 0.02 | |
| 16.96 | >10.662 | 2.51 | 0.03 | |
| 17.95 | >10.0747 | 2.52 | 0.01 | 91.66 |
| 18.96 | >9.5401 | 2.52 | 0.00 | |
| 19.95 | >9.0657 | 2.52 | 0.00 | |
| 22.47 | >8.0492 | 2.57 | 0.05 | |
| 24.97 | >7.2425 | 2.6 | 0.03 | |
| 27.46 | >6.5858 | 2.6 | 0.00 | |
| 29.96 | >6.0365 | 2.6 | 0.00 | |
| 33.71 | >5.3649 | 2.61 | 0.01 | |
| 36.72 | >4.9252 | 2.63 | 0.02 | |
| 40.76 | >4.4377 | 2.64 | 0.01 | |
| 46.1 | >3.9234 | 2.64 | 0.00 | |
| 52.29 | >3.4592 | 2.64 | 0.00 | |
| 56.34 | >3.2102 | 2.64 | 0.00 | |
| 71.86 | >2.5169 | 7.49 | 4.85 | |
| 86.91 | >2.081 | 78.77 | 71.28 | |
| 112.78 | >1.6038 | 91.01 | 12.24 | |
| 136.76 | >1.3225 | 93.39 | 2.38 | |
| 171.79 | >1.0528 | 94.17 | 0.78 | |
| 216.3 | >0.8362 | 94.7 | 0.53 | 1.01 |
| 266.7 | >0.6782 | 94.9 | 0.20 | |
| 326.74 | >0.5535 | 94.97 | 0.07 | |
| 416.47 | >0.4343 | 95.15 | 0.18 | |
| 517.12 | >0.3497 | 95.18 | 0.03 | |
| 637.01 | >0.2839 | 95.18 | 0.00 | |
| 718.16 | >0.2518 | 95.18 | 0.00 | |
| 797.15 | >0.2269 | 95.18 | 0.00 | |
| 987.16 | >0.1832 | 95.18 | 0.00 | |
| 1092.6 | >0.1655 | 95.18 | 0.00 | |

The porosity of the heating element 40 measured by the mercury intrusion method of the heating element 40 according to the above manufacturing embodiments was 60.9%. In addition, in the pore size distribution measured by the mercury intrusion method, the proportion of micropores with the pore size between 1 μm and 10 μm in micropores of the porous heating element 40 was 91.66%; and the proportion of micropores with the pore size between 1 μm and 10 μm was greater than 90%. In addition, the proportion of micropores with the pore size between 10 μm and 20 μm in micropores of the heating element 40 was 0.14%. In addition, the proportion of micropores with the pore size greater than 20 μm in micropores of the heating element 40 was 2.37%. In addition, the proportion of micropores with the pore size smaller than 1 μm in micropores of the heating element 40 was 1.01%.

In addition, further, in the pore size distribution measured according to the foregoing mercury intrusion method, more than 90% of the micropores have the pore size between 1.6 μm and 2.5 μm, and the concentration degree is high. It shows that the pore size of the micropores in the whole heating element 40 is uniform.

In addition, during implementation, the average pore size of the micropores in the porous heating element 40 is distributed from 1 μm to 10 μm. In some other implementations, the average pore size distribution of 1 μm to 4 μm for the micropores in the porous heating element 40 is advantageous.

Or, in some other variant embodiments, by adjusting the manufacturing reaction conditions or the quantity of the solvent, the proportion of the micropores with the pore size of 4 μm to 7 μm in the manufactured porous heating element 40 is greater than 85%.

During implementation, the porous heating element 40 is basically porous carbon; and the volume resistivity of the porous heating element 40 is 0.1 Ω·mm to 1 Ω·mm. Further, it is advantageous to keep the volume resistivity of the porous heating element 40 between 0.5 Ω·mm and 0.8 Ω·mm.

During implementation, the volume of the porous heating element 40 is not greater than 8 mm³; further, the volume of the porous heating element 40 is maintained not greater than 5 mm³; and it is advantageous for improving the heat utilization efficiency and reducing dissipation. The foregoing volume of the porous heating element 40 refers to an apparent (macroscopic) volume.

During implementation, an apparent area of the porous heating element 40 should be not less than 5 mm²; and further, the apparent area of the porous heating element 40 should be maintained not less than 5 mm², and it is advantageous for transferring the liquid substrate or heat.

Or, after step S30 and before step S40, activation treatment is performed on the heating element precursor obtained through manufacturing in step S30, so that a great number of activated micropores are further generated on a wall of a framework of the heating element 40; and the pore size of the micropores generated through activation is generally smaller than 2 nm. In some embodiments, according to the activation treatment on the heating element precursor, calcination is performed again in an atmosphere of an active gas such as water vapor or carbon dioxide, and the active gas takes a reaction with active sites on the surfaces of the pores of the heating element precursor to realize activation; or in some other embodiments, according to the activation treatment on the heating element precursor, the heating element 40 is immersed in a potassium hydroxide solution, a zinc chloride solution, etc. so that the active sites on the surfaces of the pores of the heating element precursor take a reaction to realize activation.

In addition, it can be seen from the above figure that the surface of the porous framework of the heating element 40 sintered through resin gel is basically smooth, and is at least smoother than the surface of the framework formed through sintering via a pore forming material.

For example, FIG. 15 is a comparison diagram of nitrogen gas adsorption and desorption curves of the foregoing heating element 40 tested by using a nitrogen gas adsorption and desorption instruction before and after once more calcination (the calcination temperature is 1000° C. to 1500° C.) activation of the above heating element 40 in a carbon dioxide atmosphere. According to comparison of the tested adsorption and desorption curves in FIG. 15, the nitrogen gas adsorption and desorption curve of the heating element 40 before activation is a type II isotherm, and the nitrogen gas adsorption and desorption curve of the heating element 40 after activation is a type I isotherm. After activation, a great number of activation pores (<2 nm) exist on the surface of the framework of the heating element 40, so a great gas adsorption quantity is shown in an ultra-low pressure area near 0, and the adsorption and desorption curve is the type I isotherm; and the adsorption and desorption curve of the nonactivated heating element 40 is the type II isotherm.

The foregoing nitrogen gas adsorption and desorption curves are characterization curves for describing the nitrogen gas physical adsorption characteristics of the porous material in the material test field; and in this characterization, the nitrogen gas adsorption and adsorption curves of the porous material are finely divided into six types: type I, type II, type III, type IV, type V and type VI.

During implementation, the porous heating element 40 only includes inorganic non-metallic elements such as carbon, nitrogen and silicon, but does not include a metallic element. The porous heating element 40 achieves strong acid resistance and strong alkali resistance, and has no metal dissolution which may pollute the liquid substrate. If the metal salt is used as a catalyst in the polymerization reaction, only a very small quantity of metal ion residues from the catalyst are contained in the heating element 40, and these residue metallic components may be taken out through soaking in water or an acidic solution, so it may be basically ignored; or the heating element 40 basically contains no metallic element.

During implementation, the Moh's hardness of the porous heating element 40 is 2 to 3, and it is advantageous for reducing powder falling.

In addition, during implementation, the porous heating element 40 has the mechanical strength not smaller than 20 MPa. A method for testing the mechanical strength is implemented with reference to the national standard GB/T 1041-2008.

In addition, during implementation, the volume density of the porous heating element 40 is: 0.4 g/cm³ to 1 g/cm³.

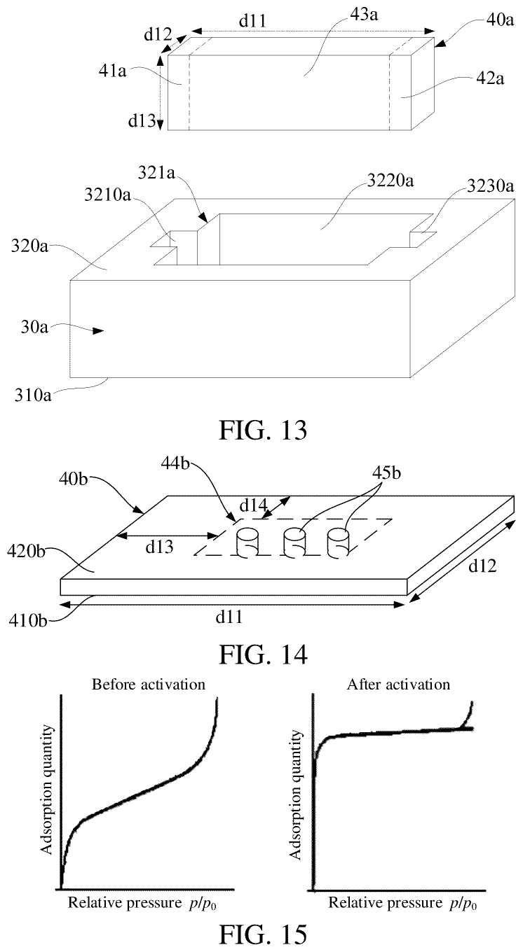

Or, FIG. 13 is a schematic diagram of an atomization assembly according to another variant embodiment. In this embodiment, the atomization assembly includes:
a porous body 30a; and a porous heating element 40a.

A surface 320a of the porous body 30a is provided with a first side end and a second side end which back away from each other in a length direction; and a groove 321a includes a section 3210a close to the first side end, a section 3230a close to the second side end, and a section 3220a located between the section 3210a and the section 3230a. The heating element 40a is assembled and held in the groove 321a.

In addition, in the embodiment of FIG. 13, a length size d11 of the heating element 40a may be about 6 mm to 12 mm; and a width size d12 of the heating element 40a may be about 1 mm to 4 mm; and a height size d13 of the heating element 40a may be about 2 mm to 6 mm; and the height size d13 of the heating element 40a is greater than the width size d12 of the heating element 40, so that the heating element 40a is in a vertical or standing state rather than a lying state when being held in the groove 321a. Or, in more variant embodiments, the heating element 40a may be in a cylindrical shape, a prismatic shape with a polygonal cross section, or the like.

In addition, during implementation, the approximate width sizes of the section 3210a and the section 3230a of the groove 321a are the same as the width size d12 of the heating element 40a; and for example, the section 3210a and the section 3230a have a width size about 1 mm to 4 mm. In addition, the width size of the section 3220a is greater than the width size of the section 3210a/the section 3230a/the heating element 40a; and during implementation, the width size of the section 3220a is about 3 mm to 6 mm.

In addition, a length size of the section 3220a is smaller than the length size d11 of the heating element 40a; and the length size of the section 3220a may be about 4 mm to 10 mm; and therefore, after the assembly, the heating element 40a spans across the section 3220a in the length direction. Moreover, after the assembly, the heating element 40a passes through or extends from the section 3210a to the section 3230a.

In addition, the heating element 40a includes:
a portion 41a, being close to and defining a first end of the heating element 40a in the length direction, and defining a first electric connection portion of the heating element 40a through coming in contact or covering the electrode after the assembly;
a portion 42a, being close to and defining a second end of the heating element 40a in the length direction, and defining a second electric connection portion of the heating element 40a through coming in contact or covering the electrode after the assembly; and
a portion 43a, located between the portion 41a and the portion 42a, and mainly configured to define a heating portion of the heating element 40a.

During assembly, the portion 41a is accommodated and held in the section 3210a of the groove 321a, and the portion 42a is accommodated and held in the section 3230a of the groove 321a; and the portion 43a is accommodated and held in the section 3220a of the groove 321a.

Moreover, after assembly, the heating element 40a is flushed with the surface 320a of the porous body 30a or is 1 mm to 2 mm lower than the surface 320a. Moreover, the heating element 40a at least does not protrude out relative to the surface 320a.

Moreover, after the assembly, an inner side surface of the section 3220a is mainly not in contact with a side surface of the portion 43a of the heating element 40a; and a space exists between the inner side surface of the section 3220a and the side surface of the portion 43a, and a width of the space is about 1 mm to 2 mm. The space is defined at two sides of the width direction of the portion 43a of the heating element 40a, so as to provide a space for the heating element 40a to release the aerosol.

Further, referring to FIG. 13, a depth of the groove 321a is substantially constant in the length direction, and the depth of the groove 321a is basically equal to the height size d13 of the heating element 40a. Therefore, after the assembly, a lower end surface of the heating element 40a is attached to or in contact with a bottom wall of the groove 321a, so as to suck the liquid substrate. Moreover, after the assembly, an upper end surface of the heating element 40a is basically exposed. In addition, a contact area of the portion 43a with the porous body 30a is smaller than 25% of an external surface area of the portion 43a; and it is advantageous for limiting contact and reducing heat transfer.

Or, FIG. 14 is a schematic diagram of a porous heating element 40b according to another variant embodiment; and in this embodiment, the flaky porous heating element 40b is provided with through holes 45b penetrating through heating element 40b in the thickness direction. Specifically,
the surface 410b of the heating element 40b in the thickness direction is a surface attached to or in contact with the porous body 30; and the surface 420b is a bare surface. In addition, in a contact process, the liquid substrate sucked from the porous body 30 is transferred from the surface 410b of the heating element 40b to the surface 420b. In a transferring process, the liquid substrate received in a central area 44b of the heating element 40b is transferred significantly lowlier than that in a peripheral edge area. Therefore, the formation of the penetrating through holes 45b in the thickness direction in the central area 44b is advantageous to the lift of the liquid substrate on the surface 420b of the central area 44b.

In addition, in the embodiment, the through holes 45b are close to a geometric center of the heating element 40b.

In addition, in the embodiment, the quantity of the through hole(s) 45b may be one or more.

In addition, in the embodiment, the through holes 45b are arranged in a predetermined direction, for example, the thickness direction; or the through holes 45b orderly extend or are orderly arranged. In addition, micropores in the heating element 40b are not arranged by order.

In addition, in the embodiment, the through holes 45b are formed in a manner such as laser perforation or erosion.

In addition, in the embodiment, the diameter of the through holes 45b is greater than the pore size of the micropores in the heating element 40b. In addition, in the embodiment, the diameter of the through holes 45b formed through laser, etc. may be between 0.05 mm and 1.0 mm. Preferably, the diameter of the through holes 45b is about 0.1 mm to 0.5 mm. In addition, in the embodiment, the through holes 45b having relatively large diameters formed in a manner such as laser perforation or hole formation are visible to the naked eyes.

In addition, in the embodiment, a distance d13 between the central area 44b and the first side end and/or the second side end of the heating element 40b in the length direction is basically ½ of the length size d11 of the heating element 40b. Or, a distance d14 between the central area 44b and the upper side end and/or the lower side end of the heating element 40b in the width direction is basically ½ of the width size d12 of the heating element 40b.

Or, in some other variant embodiments, through holes 45b penetrating through the heating element 40b may also be formed in another portion except for the central area 44b of the heating element 40b in a manner such as laser perforation, and it is advantageous for rapidly supplementing the liquid substrate into the heating element 40b in the heating process to prevent dry burning. Or, the foregoing through holes 45b may be formed in any area of the heating element 40b.

It should be noted that, the specification and the accompanying drawings of this application illustrate exemplary embodiments of this application, but this application is not limited to the embodiments described in this specification. Further, a person of ordinary skill in the art may make improvements or modifications according to the above description, and all the improvements and modifications shall fall within the protection scope of the appended claims of this application.

1. An atomizer, comprising:
a liquid storage cavity for storing a liquid substrate;
a porous body, in fluid communication with the liquid storage cavity to receive the liquid substrate; and
a heating element, at least partially coming in contact with the porous body, wherein the heating element is porous for suctioning the liquid substrate from the porous body and heating the suctioned liquid substrate to generate an aerosol; and the heating element is obtained by carbonizing a porous resin gel.

2. The atomizer according to claim 1, wherein the heating element does not comprise a metallic element; or
the heating element is nonmetallic.

3. The atomizer according to claim 1, wherein the heating element comprises carbon.

4. The atomizer according to claim 1, wherein the heating element further comprises nitrogen or silicon.

5. The atomizer according to claim 1, wherein a porosity of the heating element is between 30% and 80%.

6. The atomizer according to claim 1, wherein an average pore size of micropores in the heating element is between 1 μm and 10 μm.

7. The atomizer according to claim 1, wherein a volume of the heating element is not greater than 8 mm³.

8. The atomizer according to claim 1, wherein a volume density of the heating element is 0.4 g/cm³ to 1 g/cm³.

9-10. (canceled)

11. The atomizer according to claim 1, wherein the micropores in the heating element are basically three-dimensionally communicated.

12. (canceled)

13. The atomizer according to claim 1, wherein a volume resistivity of the heating element is between 0.1 Ω·mm and 1 Ω·mm.

14. The atomizer according to claim 1, wherein the porous resin gel is obtained by enabling organic monomers capable of being polymerized with the formaldehyde to take a polymerization reaction with formaldehyde, and separating a resin product from a reaction system through phase separation.

15-16. (canceled)

17. The atomizer according to claim 1, wherein:
through holes orderly formed in a predetermined direction are further formed on the heating element; and
the through holes penetrate through the heating element in a thickness direction of the heating element.

18. The atomizer according to claim 1, wherein:
through holes orderly formed in a predetermined direction are further formed on the heating element; and
a hole size of the through holes is greater than a pore size of the micropores in the heating element; and/or a diameter of the through holes is between 0.05 mm and 1.0 mm.

19. (canceled)

20. The atomizer according to claim 1, wherein:
through holes orderly formed in a predetermined direction are further formed on the heating element; and
the heating element is flaky; and the through holes are at least located in a central area of the heating element.

21. The atomizer according to claim 1, wherein the heating element is provided with a framework defining internal micropores, and activation pores smaller than 2 nm are formed on a surface of the framework.

22. (canceled)

23. The atomizer according to claim 1, wherein a nitrogen gas absorption and desorption curve of the heating element is a type I isotherm.

24. An electronic atomization device, comprising an atomizer for atomizing a liquid substrate to generate an aerosol, and a power supply mechanism for supplying power to the atomizer, wherein the atomizer comprises the atomizer according to claim 1.

25-31. (canceled)

32. A manufacturing method for an atomization assembly, comprising:
enabling organic monomers capable of being polymerized with aldehyde compounds to take a polymerization reaction with the aldehyde compounds, and separating a resin product of the polymerization reaction from a reaction system through phase separation to obtain a porous resin gel;
carbonizing the porous resin gel to obtain a heating element; and
obtaining a porous body, and combining the heating element onto the porous body.

33. The manufacturing method for an atomization assembly according to claim 32, wherein a mole ratio of the organic monomers to the aldehyde compounds is 1.1 to 5.0.
